(19) United States
(12) Patent Application Publication
(10) Pub. No.: US 2004/0040122 A1
(43) Pub. Date: Mar. 4, 2004

(54) Binder clip with enforcing ribs

(76) Inventor: Jin Huang, Ninghai County (CN)

Correspondence Address: Richard P. Berg, Esq., c/o LADAS & PARRY, Suite 2100, 5670 Wilshire Boulevard, Los Angeles, CA, 90036-5679, US

(21) Appl. No.: 10/326,217

(22) Filed: Dec. 20, 2002

(30) Foreign Application Priority Data
Aug. 29, 2002 (CN) 02129516.6

(51) Int. Cl. B42F 1/00

(52) U.S. Cl. 24/67.5

(57) ABSTRACT

The present invention discloses a binder clip comprising two actuating arms and a single piece clip body of isosceles triangular cross section consisting of a top wall and two side walls, wherein the free end of each side wall extends outwardly to form two separate hinge hooks acting as gripping edges of the clip body, each actuating arm is disposed at the outside of the respective side wall with a form of “Ω” and includes a main portion and two legs, said legs are fitted into the hinge hooks such that the actuating arms are pivoted about the hinge hooks, characterized in that ribs are provided on said top wall and/or on the side walls. Various forms of ribs are described in the present invention. The advantage is that a binder clip with larger opening can be obtained and at the same time, saving the material.

### TECHNICAL FIELD

The present invention relates to a binder clip, in particular, to a binder clip with enforcing ribs(which will be hereinafter called merely the “ribs” from time to time).

Binder clip is commonly used in the office for temporarily binding individual sheets, paper pieces or notes and so on together without causing any damage to the same. Such a binder clip should satisfy the requirements in the following aspects: a) it must have sufficient clamping force so as to ensure that the retained paper does not fall off, thus preventing the paper from missing; b) it should be easily used and can be put into operation and released without too much force; c) it should be robust and durable with poor risk of being damaged; and d) it has lower weight.

### BACKGROUND ART

It is known from the prior art that the conventional clip of such a kind usually comprises:

1) a corrugated paper clip, which has a simple structure and lower weight and can be conveniently used, the shortcoming of such a clip is that it has poor durability and tends to lose its elasticity after being used several times, on the other hand, it generates small clamping force and can only be used to hold a few paper pieces and further, the clamping force becomes insufficient once more paper pieces are held, thus the paper tends to become loose and falls off, finally, the uppermost sheet tends to be scratched;

2) a clip, which consists of two opposite clip bodies with the integral handles connected by a pin and a spring mounted on the pin, such a clip is durable, generates big clamping force and causes less damage to the retained paper, but the disadvantage lies in its larger weight and size, which renders it unsuitable to be stacked on the top of one another; and

3) binder clip widely used at present, which consists of actuating arms and a clip body of isosceles triangular cross section, wherein the clip body is formed as a single piece with a top wall and two side walls connected with the top wall, the actuating arms are arranged at both sides of gripping edges and can be pivoted about the gripping edges. Such a binder clip produces good clamping force and can be operated conveniently. The clip is opened by applying pressure on the actuating arms after they are turned against the side walls, then the sheets to be held are put into the opening, the operation is finished and the paper sheets are held in position after the actuating arms are released. The force exerted for opening this clip is smaller than the second kind of clip mentioned above and further, such a binder clip has small size. Although this third kind of binder clip has good performance, it is found in practical use that only a small amount of paper sheets can be retained. If the clip is made large in size in order to accommodate more paper sheets, the thickness of the wall of the clip body must be increased, that is, the weight of the clip in question as well as the cost is increased accordingly; on the other hand, the existing binder clip of this kind is rather dull-from the view point of appearance.

### CONTENTS OF THE INVENTION

The object of the present invention is, therefore, to provide a binder clip having ribs in which the above defects are overcome.

According to the first technical solution of the present invention, the binder clip comprises two actuating arms and a single piece clip body of isosceles triangular cross section consisting of a top wall and two side walls, wherein the free end of each side wall extends outwardly to form two separate hinge hooks acting as gripping edges of the clip body, and each actuating arm is disposed at the outside of the respective side wall with a form of “Ω” and includes a main portion and two legs that are fitted into the hinge hooks such that the actuating arm can be pivoted about the hinge hooks, characterized in that one or more preferably parallel ribs are provided on said top wall between the edge portions connecting the top wall and the side walls and/or on the side walls between said edge portion and the gripping edge.

According to the second technical solution of the present invention, the binder clip comprises two actuating arms and a single piece clip body of isosceles triangular cross section consisting of a top wall and two side walls, wherein the free end of each side wall extends outwardly to form two separate hinge hooks acting as gripping edges of the clip body, and each actuating arm is disposed at the outside of the respective side wall with a form of “Ω” and includes a main portion and two legs that are fitted into the hinge hooks such that the actuating arm can be pivoted about the hinge hooks, characterized in that two or more ribs preferably in even number are provided on the top wall and/or the side walls, said ribs are inclined with respect to the edge portion connecting the top wall and the side wall in directions intersecting with each other, and the ribs with the same inclination direction are preferably parallel with each other.

The clamping body is made of steel sheet by stamping. The free ends of the two side walls extend outwardly and constitute two separate hinge hooks respectively. The actuating arm is made of steel wire and in the form of “ω”, the upper part of which is a main portion and in the opposite lower end, i.e. the free end, are formed two legs that are inserted into the hinge hooks formed on the clip body. Therefore, the actuating arm can be pivoted about the hinge hook. The length of the main portion of the actuating arm is at least larger than or, preferably, is 1.5-3.5 times that of the side wall of the clip body.

As is well known, when the binder clip is used, force in opposite directions is exerted on the upper ends of the main portions of the actuating arms, and the lever fulcrum(pivot) of such an action lies in the point where the edge portion connecting the top wall and side wall of the clip body contacts the actuating arm, and the movable point is the leg of the actuating arm inserted into the hinge hook of the clip body. Obviously, the amount of the paper sheets to be retained or the thickness of the article to be retained depends upon the width of the opening, which relates directly to the squeezing force exerted on the contacting area between the actuating arm and the edge portion connecting the top wall and the side wall. The larger the opening becomes, the larger the force acting on the above contacting area is, or in other words, the larger the squeezing force acting on the top wall in opposite directions is. On the other hand, the width of the opening relates to the force acting on the side wall. The side wall is subjected to bending force when the gripping edges are spread apart and such bending force increases with the increasing of the opening width. The remedy to this in the prior art is to form the top wall with inward concave curvature, and no improvement is made to the side wall. Whereby the use of such a binder clip is limited to certain extent. If it is desired to further increase the opening width, that is, increasing the retaining capacity of the binder clip, the feasible way is to increase the thickness of the clip body in addition to the increasing in size of the binder clip, causing the resultant raising in weight and cost.

The solution proposed by the applicant is to provide ribs on the top wall and/or side wall, so that the ability to resist the flexure of the top wall and the side wall is greatly enhanced. Such a solution also leads to a reduction of the thickness of the steel sheet for forming the clip body, thereby reducing the cost.

According to the first aspect of the present invention, the enforcing ribs arranged on the top wall extend between the edge portions connection the top wall and the two side walls of the clip body. The ribs can be straight-lined, inclined or even curved. Generally, the allowable inclination does not exceed 45°, preferably not exceed 30°, so as to ensure the bending strength of the top wall. Accordingly, the ribs on the top wall can be in form of a straight line, elongated “S” shape, “<” shape, curved shape or other similar shapes. The ribs arranged on the side wall extend between the edge portion connecting the top wall and the side wall and the grip edge portion, and these ribs can be straight-lined, inclined or even curved. Generally, the allowable inclination does not exceed 45°, preferably not exceed 30°, so as to ensure the bending strength of the side walls, just as the ribs on the top wall. Accordingly, the ribs on the side walls can be in form of a straight line, elongated “S” shape, “<” shape, curved shape or other similar shapes. When two or more ribs are provided, they should be parallel with each other.

According to the second solution of the present invention, two or more ribs preferably in even number are provided on the top wall and/or the side walls. The ribs are arranged in such a way that the bending strength at the two sides of the central line of the width of the top wall and/or side walls is increased substantially identically. Therefore, in the case of two ribs, they can be in the form of “/\” or “X” or “Λ”, and when there are a pluralities of ribs, a net structure with one or more identical quadrangles is formed as a whole.

The binder clip according to the present invention has the advantage of high clamping force and the ability to accommodate more paper pieces, and additionally, it has lower weight and can be used easily. Also, the shortcoming of dull appearance of the existing structure is overcome.

These and other objects and features of the present invention will be apparent from the following detailed description, with reference to the figures of the accompanying drawings.

### BRIEF DESCRIPTION OF THE DRAWINGS

FIG. 1 is a front view of the first embodiment of the binder clip with the ribs according to the invention, in non-use state;

FIG. 2 is a side view of the binder clip shown in the FIG. 1;

FIG. 3 is a bottom view of the binder clip shown in FIG. 1;

FIG. 4 is a partial enlarged view showing portion A in FIG. 2;

FIG. 5 is a partial enlarged view showing portion B in FIG. 1;

FIG. 6 is an enlarged sectional view along line C-C in FIG. 1;

FIG. 7 is an enlarged sectional view along line D-D in FIG. 3;

FIG. 8-FIG. 11 show different forms embodying the ribs;

FIG. 12-FIG. 15 show different forms embodying the cross section of the ribs;

FIG. 16 is a front view of the second embodiment of the binder clip with the ribs according to the invention, in non-use state;

FIG. 17 is a side view of the binder clip shown in FIG. 16;

FIG. 18 is a bottom view of the binder clip shown in FIG. 16;

FIG. 19 is an enlarged sectional view along line E-E in FIG. 18;

FIG. 20 is an enlarged sectional view along line F-F in FIG. 18.

### DESCRIPTION OF THE PREFERRED EMBODIMENT

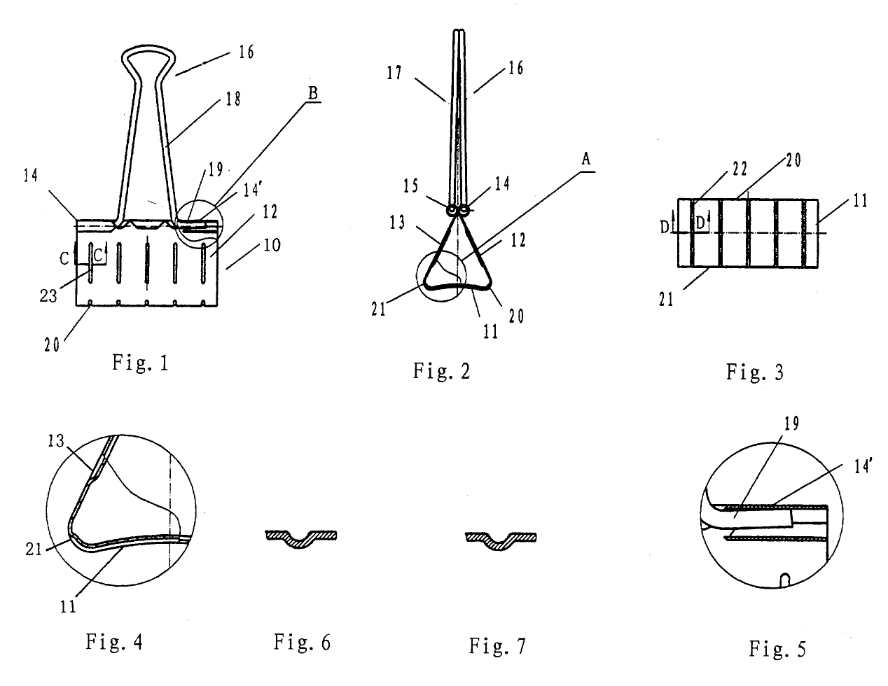

The first embodiment of the binder clip with ribs according to the present invention is now described firstly with reference to FIGS. 1-3. As shown in the figures, the binder clip includes a clip body 10 consisting of a top wall 11 and two side walls 12 and 13 connected with said top wall 11 respectively. The top wall and the side walls are connected to each other in such a way that they form an isosceles triangle in cross section(see FIG. 2). The free end of each side wall 12 or 13 extends outwardly and form two separate hinge hooks. Only hinge hooks 14 and 14′ formed on side wall 12 can be seen in FIG. 1. The hinge hooks formed on the two side walls constitute the gripping edges of the clip body. The binder clip also includes two actuating arms 16 and 17 in “Ω” shape, which consist of a main section 18 and legs 19 respectively, wherein the legs 19 are inserted into the hinge hooks of the clip body (see FIG. 1 and FIG. 5). Therefore, the actuating arms are placed to be pivotable about the hinge hooks in order to control the opening or closing of the clip body.

Now with reference to the FIGS. 2 and 4, the top wall 11 of the clip body is arched, thereby the top wall 11 itself can withstand certain bending force, thus increasing the strength of the clip body.

The ribs on the top wall 11 of the clip body are now described with reference to FIG. 3. The ribs 22 are formed straight-lined between and substantially perpendicular to the edge portions 20 and 21 connecting top wall 11 and the side walls 12,13, and all the ribs shown in this figure are parallel with each other. FIG. 7 illustrates a sectional view along D-D line of FIG. 3 and the cross section of the ribs 22 shown therein is curved with a downward convexity, that is, the ribs 22 project towards the inner side of the top wall 11.

The ribs on the side wall 12 of the clip body are described with reference to FIG. 1. The ribs on the side wall 13 are the same as those on the side wall 12. As can be seen from FIG. 1, ribs 23 are formed straight-lined between the edge portion 20, which connects the top wall 11 and the side wall 12, and the gripping edge. The ribs 23 are essentially perpendicular to said edge portion 20 and are parallel with each other as shown in this FIG. 1. FIG. 6 is a sectional view along line C-C in FIG. 1, and the cross section of ribs 23 in FIG. 6 is shown curved with a downward convexity, that is, ribs 23 project towards the inner side of the side wall 12. The ribs on the side wall 13 are identical and symmetrical with those on the side wall 12(for example, the ribs on the side wall 13 also project towards the inner side), such that the force is equally exerted onto the side walls 12 and 13.

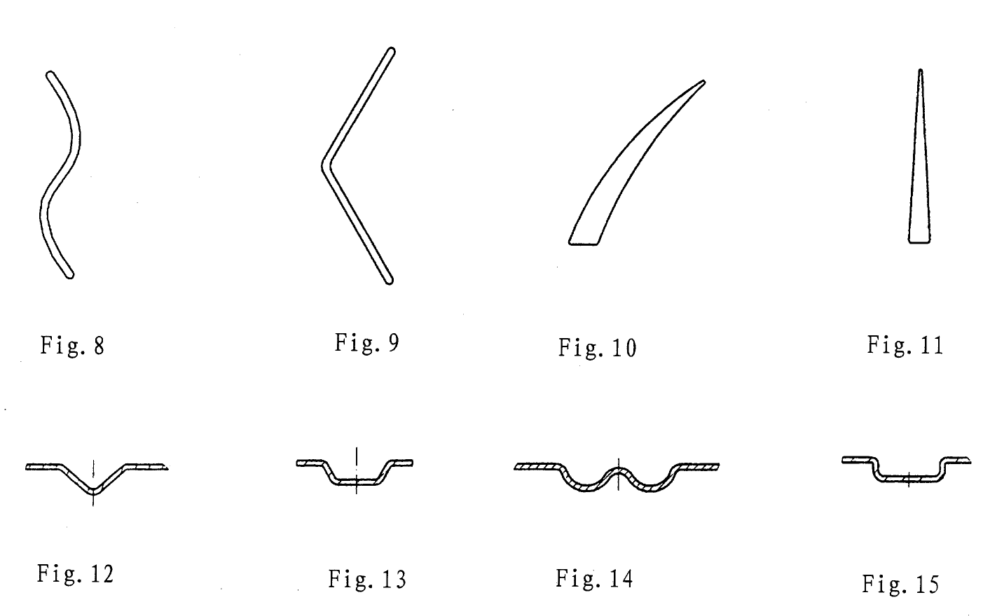

A modified embodiment of the form of the ribs is now described with reference to FIGS. 8-11. The rib shown in FIG. 8 presents a shape of elongated “S”, in FIG. 9 a shape of “<”, in FIG. 10 a shape of partial crescent and in FIG. 11 an isosceles triangle with a very short bottom. It is understood that the scope of the present invention includes but not limited to the embodiments shown in the figures. It should be noted that all the ribs project towards the inner side of the top wall 11 and side walls 12,13 respectively. It should be pointed out that the ribs should be distributed evenly so as to ensure a uniform bending strength.

FIG. 12 to FIG. 15 show modified shapes of the cross section of the ribs. It is shown a cross section of triangle in FIG. 12, trapezium in FIG. 13, wave form in FIG. 14 and rectangle form in FIG. 15. It is understood that the scope of protection includes, but not limited to, the embodiments shown in these figures.

In binder clip with ribs according to the present invention, the rib has a width of 0.1-20 mm, a depth of 0.1-2 mm and a length of 2-50 mm. It is understood that the present invention includes but is not limited to the above range of values. It should be noted that the width of the ribs shown in FIGS. 10 and 11 means its maximum width measured at the large end.

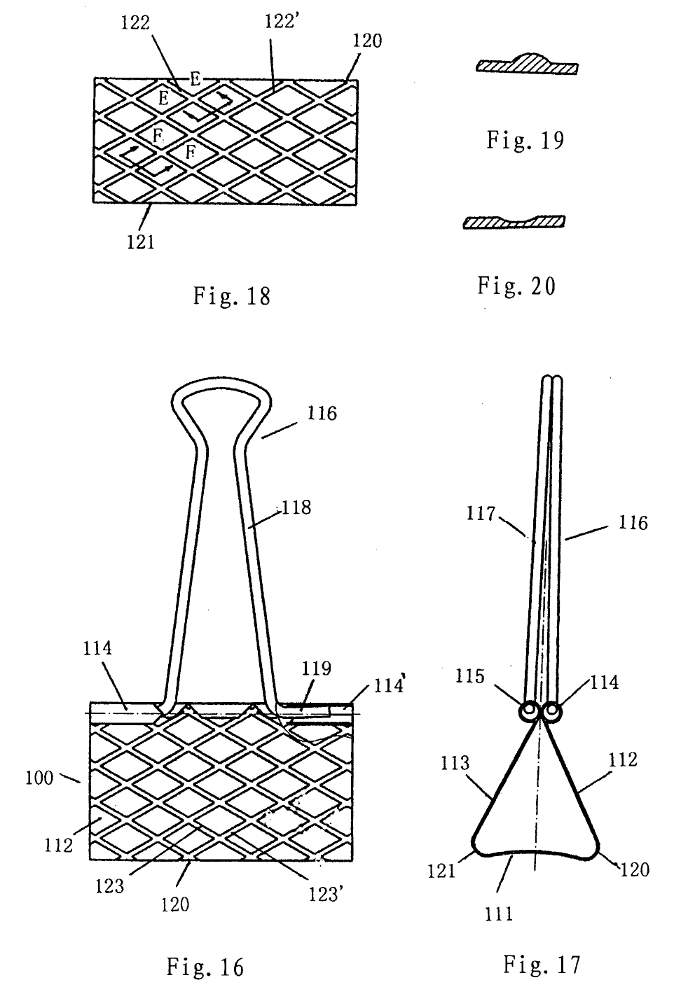

Now the second embodiment of the binder clip according to the present invention is described with reference to FIGS. 16-18. The binder clip shown in these figures includes a clip body 100 with isosceles triangular cross section(FIG. 17), which consists of a top wall 111 and two side walls 112 and 113 connected with said top wall. The free ends of each side wall 112 or 113 extends outwardly and form two separate hinge hooks. Only hinge hooks 114 and 114′ formed on the side wall 112 can be seen in FIG. 16. The hinge hooks on the side walls constitute the gripping edges of the binder clip. The binder clip also comprises two actuating arms 116 and 117 in “Ω” shape, which consist of a main section 118 and legs 119 respectively, wherein the legs 119 are inserted into the hinge hook of the clip body(see FIG. 16 and FIG. 17). Accordingly, the actuating arm can pivot about the hinge hook in order to control the opening or closing of the clip body.

Referring now to FIG. 17, the top wall 111 of the clip body may be arch-shaped, therefore, the top wall 111 itself can withstand certain bending force such that the strength of the clip body is increased.

The ribs on the top wall 111 are now described with reference to FIG. 18. As is shown in this figure, the ribs 122 and 122′ are formed straight-lined with symmetry between the edge portions 120 and 121 connecting the top wall 111 and the side walls 112 and 113 and have the same inclination with respect to the edge portions 120 and 121. Two or more ribs preferably in even number may be formed on the top wall. When two ribs are provided, a shape of “/ \” or “X” or “Λ” is formed; and when there are more ribs preferably in even number, the ribs with the same inclination direction are parallel with each other, and the ribs extending in two different inclined direction intersect with each other and constitute one or more quadrangles, thus a net structure is formed as a whole.

The ribs on the side wall 112 is now described with reference to the FIG. 16. The ribs on the side wall 113 are the same as those on the side wall 12. As is shown in this figure, the ribs 123 and 123′ are formed symmetrically and have the same inclination with respect to the edge portions 120 and 121. Two or more ribs preferably in even number may be formed on the side wall. When two ribs are provided, a shape of “/ \” or “X” or “Λ” is formed; and when there are more ribs preferably in even number, the ribs with the same inclination direction are parallel with each other. The ribs extending in two different inclined directions intersect with each other and constitute one or more quadrangles, thus a net structure is formed as a whole.

The shapes of the cross section of the ribs 122 and 122′ formed on the top wall 111 and the ribs 123 and 123′ formed on the side walls 112 and 113 are now described with reference to FIG. 19 and 20. FIG. 19 shows a rib with curvature convex outwards from the top wall or from the side wall, and FIG. 20 shows ribs with concave curvature into the inner side of the top wall or side wall. It is easily understood by the person with ordinary skill in the art that the shape of the cross section is not limited to those shown in FIGS. 19 and 20, other form such as triangle or trapezium is also acceptable. The width and depth of the ribs 122,122′ and ribs 123,123′ are the same as those of ribs 22 and 23 described in the first embodiment.

Obviously various modification or variation can be made without departing from the true spirit of the present invention, for example, the ribs can be in form of inclined line or in form of crescent. It is clearly understood that the embodiments described above and shown in the figures are illustrative only and not intended to limit the scope of the present invention.

1. A binder clip comprising two actuating arms and a single piece clip body of isosceles triangular cross section consisting of a top wall and two side walls, the free end of each side wall extending outwardly to form two separate hinge hooks acting as gripping edges of the clip body, each actuating arm being disposed at the outside of the respective side wall with a form of “Ω” and including a main portion and two legs, said legs being fitted into the hinge hooks such that the actuating arms are pivoted about the hinge hooks, characterized in that one or more ribs are provided on said top wall between edge portions connecting the top wall and the side walls and/or on the side walls between said edge portion and the gripping edge.

2. A binder clip according to claim 1, characterized in that the inclination of the ribs is equal to or less than 45°.

3. A binder clip according to claim 1, characterized in that said ribs are in the form of straight line, elongated “S”, “<” shape, partial crescent or isosceles triangle with a short bottom.

4. A binder clip according to claim 3, characterized in that the cross section of said ribs is in the form of curvature, triangle, trapezoid, waveform or rectangle.

5. A binder clip according to claim 1, characterized in that said ribs have a width of 0.1-20 mm and a depth of 0.1-2 mm and a length of 2-50 mm.

6. A binder clip according to claims 1, characterized in that said top wall is in the arched form.

7. A binder clip comprising two actuating arms and a single piece clip body of isosceles triangular cross section consisting of a top wall and two side walls, the free end of each side wall extends outwardly to form two separate hinge hooks acting as gripping edges of the clip body, each actuating arm being disposed at the outside of the respective side wall with a form of “Ω” and including a main portion and two legs, said legs being fitted into the hinge hooks such that the actuating arms are pivoted about the hinge hooks, characterized in that two or more ribs are provided on the top wall and/or the side walls, said ribs being inclined with respect to edge portions connecting the top wall and the side walls in directions intersecting with each other, and the ribs in the same inclination direction are preferably parallel with each other.

8. A binder clip according to claim 7, characterized in that said ribs are in the form of straight line.

9. A binder clip according to claim 7, characterized in that the cross section of said ribs is in the form of curvature, triangle, trapezoid.

10. A binder clip according to claim 7, characterized in that said ribs have a width of 0.1-20 mm and a depth of 0.1-2 mm and a length of 2-50 mm.

11. A binder clip with ribs according to claims 7, characterized in that said top wall is in the arched form.
